(19) United States
(12) Patent Application Publication
(10) Pub. No.: US 2013/0200546 A1
(43) Pub. Date: Aug. 8, 2013

(54) VENTED MOLD TOOLING

(71) Applicants: Matthew T. Lowney, Davisburg, MI (US); Michael Wasylenko, Metamora, MI (US); Anthony Nicholas Tanascu, Washington, MI (US); Michael Browning Mast, Bloomfield Hills, MI (US)

(72) Inventors: Matthew T. Lowney, Davisburg, MI (US); Michael Wasylenko, Metamora, MI (US); Anthony Nicholas Tanascu, Washington, MI (US); Michael Browning Mast, Bloomfield Hills, MI (US)

(73) Assignee: FLOODCOOLING TECHNOLOGIES, LLC, Troy, MI (US)

(21) Appl. No.: 13/384,542

(22) PCT Filed: Jul. 15, 2010
(86) PCT No.: PCT/US10/42138

§ 371 Date: Jun. 6, 2012

Related U.S. Application Data
(60) Provisional application No. 61/225,732, filed on Jul. 15, 2009.

(51) Int. Cl. B29C 33/10

(52) U.S. Cl. CPC B29C 33/10
USPC 264/219

(57) ABSTRACT

A method for forming a tool for forming an article provides a series of laminate layers to collectively form a tool body. First and second pluralities of the laminate layers are formed with a forming surface for forming an article in a forming operation. A chamber is formed through the first and second pluralities of laminate layers offset from the forming surface. A vent is formed in each of the second plurality of laminate layers intersecting the forming surface and the chamber. The series of laminate layers are stacked such that each of the first plurality of the laminate layers is alternating with the second plurality of the laminate layers. The stacked series of laminate layers are heated to a temperature wherein the layers braze together.

### CROSS-REFERENCE TO RELATED APPLICATIONS

This application claims the benefit of U.S. provisional Application No. 61/225,732 filed Jul. 15, 2009; the disclosure of which is incorporated in its entirety by reference herein.

### BRIEF DESCRIPTION OF THE DRAWINGS

FIG. 1 is a perspective view of a first mold block;

FIG. 2 is a perspective view of a second mold block for cooperating with the first mold portion of FIG. 1;

FIG. 3 is a cross-section of the first and second mold blocks of FIGS. 1 and 2 illustrated cooperating for forming an article;

FIG. 4 is a perspective view of a first mold block portion according to an embodiment of the invention;

FIG. 5 is a perspective view of a second mold block portion according to an embodiment of the invention for cooperating with the first mold block portion of FIG. 4;

FIG. 6 is an enlarged perspective view of a region of a forming surface of the second mold block portion of FIG. 5;

FIG. 7 is a lengthwise cross section of the first mold block portion of FIG. 4;

FIG. 8 is another cross section of the first mold block portion of FIG. 4;

FIG. 9 is a fragmentary perspective view of the first mold block portion of FIG. 4 illustrated in cooperation with a manifold plate;

FIG. 10 is an enlarged section view of the first mold block portion and the manifold plate of FIG. 9;

FIG. 11 is a fragmentary perspective view of another mold block portion according to an embodiment of the invention;

FIG. 12 is another fragmentary perspective view of the mold block portion of FIG. 11;

FIG. 13 is a stress distribution model of the mold block portion of FIG. 11;

FIG. 14 is an exploded perspective view of layers of material of the mold block portion of FIG. 11 according to an embodiment;

FIG. 15 is a perspective view of layers of material of the mold block portion of FIG. 11 according to another embodiment;

FIG. 16 is a side view of the mold block portion of FIG. 11 after a first forming operation to the layers and during assembly of the layers;

FIG. 17 is a side view of the mold block portion of FIG. 11 after the first forming operation to the layers and during assembly of the layers;

FIG. 18 is another side view of the mold block portion of FIG. 11 illustrating a forming surface prior to final machining;

FIG. 19 is an exploded perspective view of the layers of the mold block portion of FIG. 11 prior to final machining;

FIG. 20 is fragmentary perspective view of the layers of the mold block portion of FIG. 11 prior to final machining;

FIG. 21 is a perspective view of a braze fixture illustrating an embodiment of the present invention;

FIG. 22 is a fragmentary perspective view of the braze fixture of FIG. 21 illustrated in cooperation with a plurality of mold block portions;

FIG. 23 is another perspective view of the braze fixture of FIG. 21 in cooperation with a plurality of mold block portions;

FIG. 24 is a perspective view of another braze fixture illustrating another embodiment of the invention in cooperation with a mold block portion;

FIG. 25 is another perspective view of the braze fixture of FIG. 24 in cooperation with a mold block portion; and

FIG. 26 is a graph of time versus temperature for a braze cycle illustrating another embodiment of the invention.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present invention relate to vented mold tooling, including inserts or other components; and manufacturing processes for the vented mold tooling. The vented mold tooling may utilize an aluminum brazing process as described below and in U.S. patent application Ser. No. 12/393,070 filed on Feb. 26, 2009 by Lowney et al., which is incorporated by reference herein.

Some manufacturing processes for forming articles require passages, or vents, to and from forming cavity surfaces of the mold tooling. Such manufacturing processes may include, but are not limited to, expanded plastic foam bead molding, blow-molding, injection-molding, and the like. Tooling for these processes typically include components such as a core, cavity, and inserts.

The convention manufacturing process to mold a product of expanded plastic foam includes placement of plastic foams beads within a mold, and a subsequent delivery of steam and water to the foam bead material which is contained within the forming tool. Expanded plastic foam materials often include, but are not limited to, polypropylene, polystyrene, and the like. Initially, pre-expanded plastic foam beads (similar in size to sand granules) are conveyed into the tool cavity. The tool then closes to a defined shut height which puts the pre-expanded plastic foam beads into compression and even distribution within the tool. Pressurized steam is delivered into a steam chest which includes a volume for containing the steam and the tool. The steam then passes through vents in the wall of the tool. The steam heats the tool and material causing expansion of the plastic foam beads and fuses the beads together. Next, the steam chest is depressurized. The cooling process occurs by filling the steam chest with water, which passes through the vents in the tool causing cooling of the plastic foam part and the tool. The part can then be removed from the tool at room temperature.

Other forming processes including, but not limited to, blow-molding, injection-molding, and the like, may also employ venting to relieve gas that may be trapped within the tool cavity during the molding process. Forming processes, such as vacuum forming also utilize venting of the tool. However, the vents are commonly passages from the tool cavity to a common chest or volume, similar to the steam chest previously described, and a vacuum source is applied to this chest or volume to generate a vacuum within the tool cavity to allow the molded material to be drawn to the forming surface of the tool.

Manufacturing of vents is commonly achieved in tools by utilizing conventional machining methods and/or inserting of vented inserts. For example, typical vented inserts are machined components that incorporate orifices, holes, porous material, or the like. The design and implementation of vents and/or vented inserts can often times be constrained by the geometry of the tool, underlying cooling channels, peripheral devices and hardware, and manufacturing methods. As a result of these constraints, efficiency of the forming process may be limited.

Utilization of a laminate process for manufacturing the tooling presents great opportunity to increase the amount of venting to the tool forming surfaces, allows increased flexibility of vent locations relative to geometry constraints, integrate steam chest or chambers into tool to provide distribution of steam, water, gas, or vacuum, and reduce manufacturing costs of the tool.

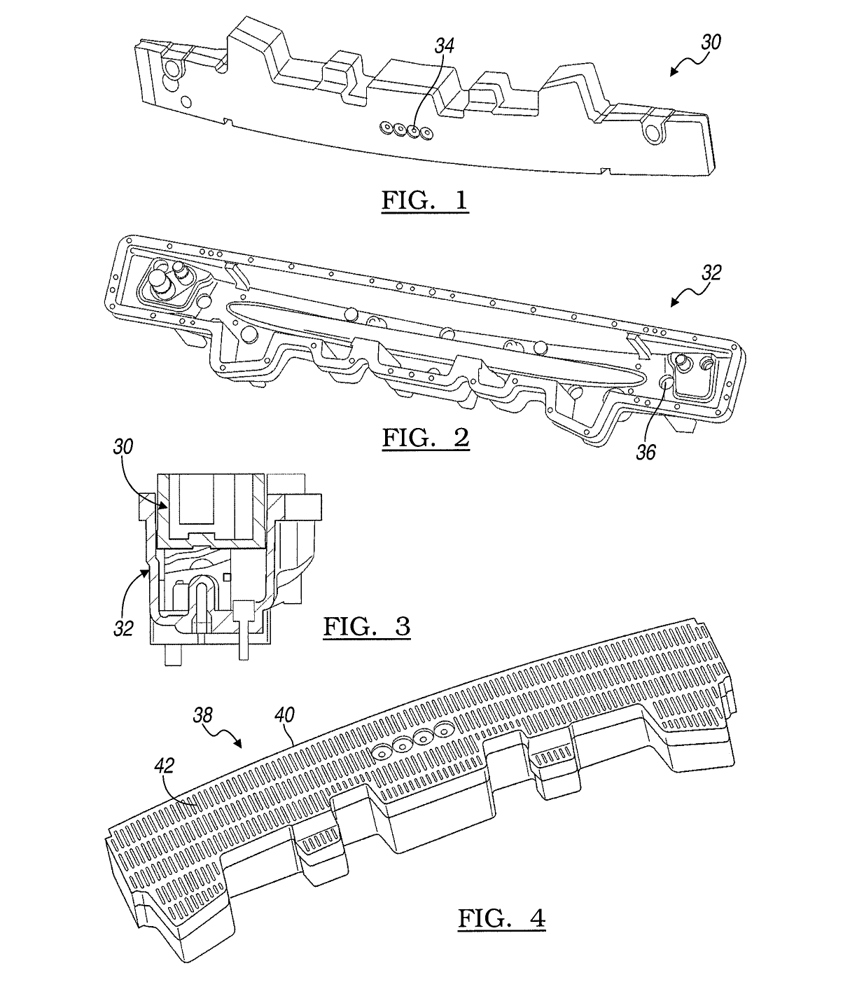

Referring now to FIG. 1, a mold core 30 is illustrated for forming an expanded foam article, such as an expanded polypropylene article. FIG. 2 illustrates a corresponding mold cavity 32 for receiving the mold core 30 in a forming operation. The mold core 30 and cavity 32 depict the respective male and female mold blocks for forming an expanded foam article such as an expanded polypropylene bumper for a vehicle. The mold core 30 is received within the mold cavity 32 during the molding operation as illustrated in FIG. 3. The foam beads are conveyed into the mold cavity 32, then compressed by the mold core 30. Steam is conveyed into the mold cavity 32 through ports 34 in the mold core 30 and ports 36 in the mold cavity 32. The mold core 30 and mold cavity 32 are housed within the steam chest (not shown) wherein steam is distributed externally to these mold blocks 30, 32 which penetrates the cavity 32 through the ports 34, 36 in the mold core 30 and mold cavity 32.

The mold core 30 and mold cavity 32 depict tooling components for molding an article, such as the expanded polypropylene bumper, which is formed utilizing the prior art method with an external steam chest. An expanded polypropylene bumper is a structural component of a vehicle that is mounted to a part of the frame of a vehicle, or unibody of a vehicle and is covered by an external bumper fascia. Impact loads that are imparted to the bumper fascia are distributed to the vehicle structure through the expanded foam bumper, which absorbs some of the impact loads, dampens some of the impact loads, and helps to evenly distribute the impact loads to the structure of the vehicle. Since this component in concealed beneath the fascia, it is a class B component. Of course, conventional steam chest mold processes are also utilized for class A surfaces for products such as consumer products including foam cups, plates, etc. with final exterior surfaces viewable to the end user. Likewise, conventional steam chest mold processes are also utilized for molding inserts that are subsequently utilized for lost foam casting.

The mold blocks 30, 32 that utilize the conventional steam chest processes are conventionally machined from solid blocks of nonferrous material, such as aluminum, stainless steel or the like. In order to penetrate the mold blocks 30, 32 the entire volume of the steam chest is filled with steam. Much energy is employed for generating sufficient steam to fill the steam chest. Additionally, cycle time is dictated by the time required for the steam to pass through the ports 34, 36 in the mold blocks 30, 32 to react with the foam beads housed therein.

Laminated tooling provides opportunities to incorporate to the design of a tool such as the mold core 30 and cavity 32. As a result these opportunities, the efficiency of the manufacturing process of the formed component is increased.

Referring now to FIG. 4, a mold core portion 38 is illustrated according to an embodiment of the invention. The mold core portion 38 may be a solid component, or may be formed from multiple components. Additionally, the mold core portion 38 depicted could be enlarged to provide the entire bumper core such as the bumper core 30. For this particular application, differing foam materials are utilized for central and lateral regions of the bumper component and therefore differing mold tool components are provided to collectively mold the bumper component. Accordingly, only a central portion 38 of the overall mold core is illustrated. The mold core portion 38 is formed from a laminate tooling process, such as that disclosed in U.S. Pat. No. 6,587,742 B2, which issued on Jul. 1, 2003 to Manuel et al.; and U.S. Pat. No. 5,031,483, which issued on Jul. 16, 1991 to Weaver; the disclosures of which are incorporated by reference herein.

The mold core portion 38 is provided by a series of laminate plates that collectively provide a forming surface 40. A series of vents 42 are formed in the forming surface 40 to convey steam from a steam chamber or a manifold (not shown) directly through the forming surface 40 to the foam particles.

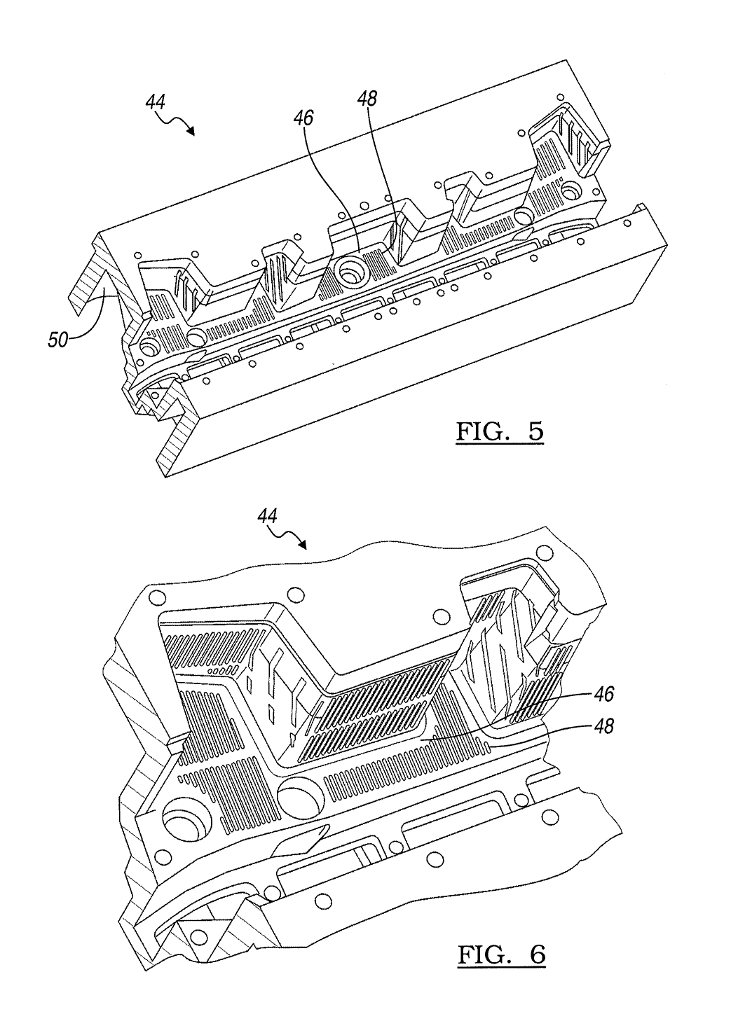

A corresponding mold cavity portion 44 is illustrated in FIG. 5. During a molding operation, the mold core portion 38 is inserted into the mold cavity portion 44 thereby compressing foam beads that are placed within the mold cavity portion 44, and subsequently for collectively conveying steam to the foam beads. Similar to the mold core portion 38, the mold cavity portion 44 can be formed from multiple components, or may be enlarged to provide the entire mold cavity for the bumper component. The mold cavity portion 44 is also formed from a laminate process. The mold cavity portion 44 includes a forming surface 46 with a series of vents 48 formed in the forming surface 46. The vents 48 are connected to a steam chamber 50 for conveying steam through the mold cavity portion 44 directly to the foam beads at the forming surface 46 of the mold cavity portion 44. FIG. 6 illustrates an enlarged region of the forming surface 46 with vents 48 of the mold cavity portion 44.

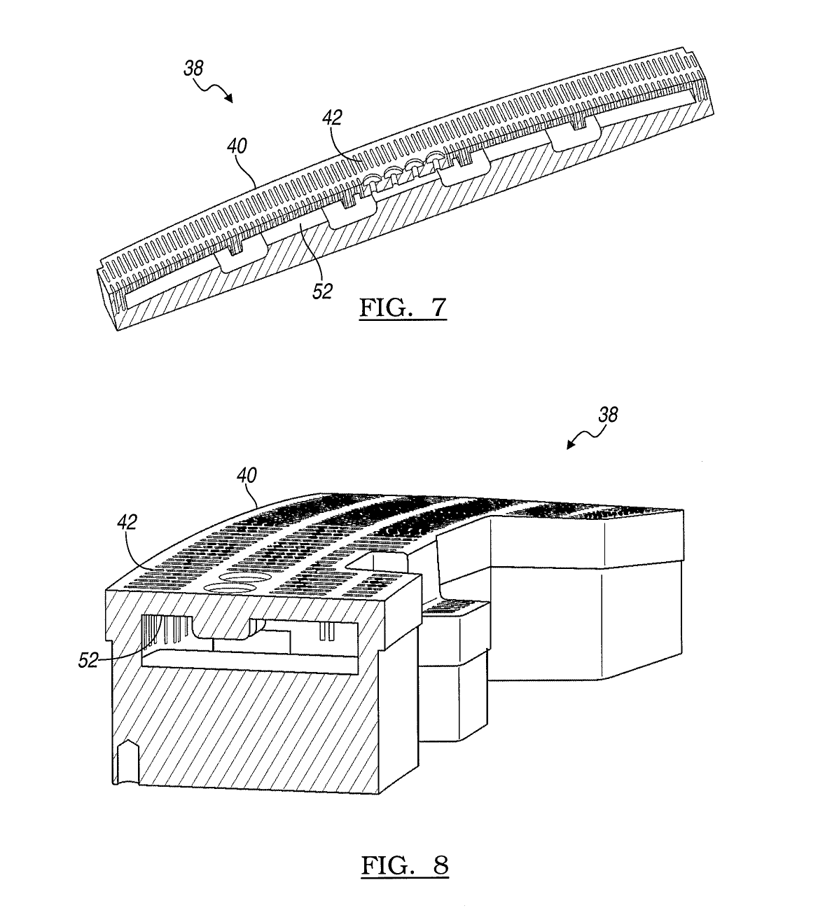

FIGS. 7 and 8 illustrate sections of the mold core portion 38 according to at least one embodiment, wherein a steam chamber 52 is provided within the body of the mold core portion 38 spaced apart from the forming surface 40. The vents 42 intersect the steam chamber 52 and the forming surface 40. Steam is conveyed into the mold core portion 38 via a port (not shown), in connection with the chamber 52 for conveying the steam through the chamber 52 and distributing it through the vents 42 along the forming surface 40.

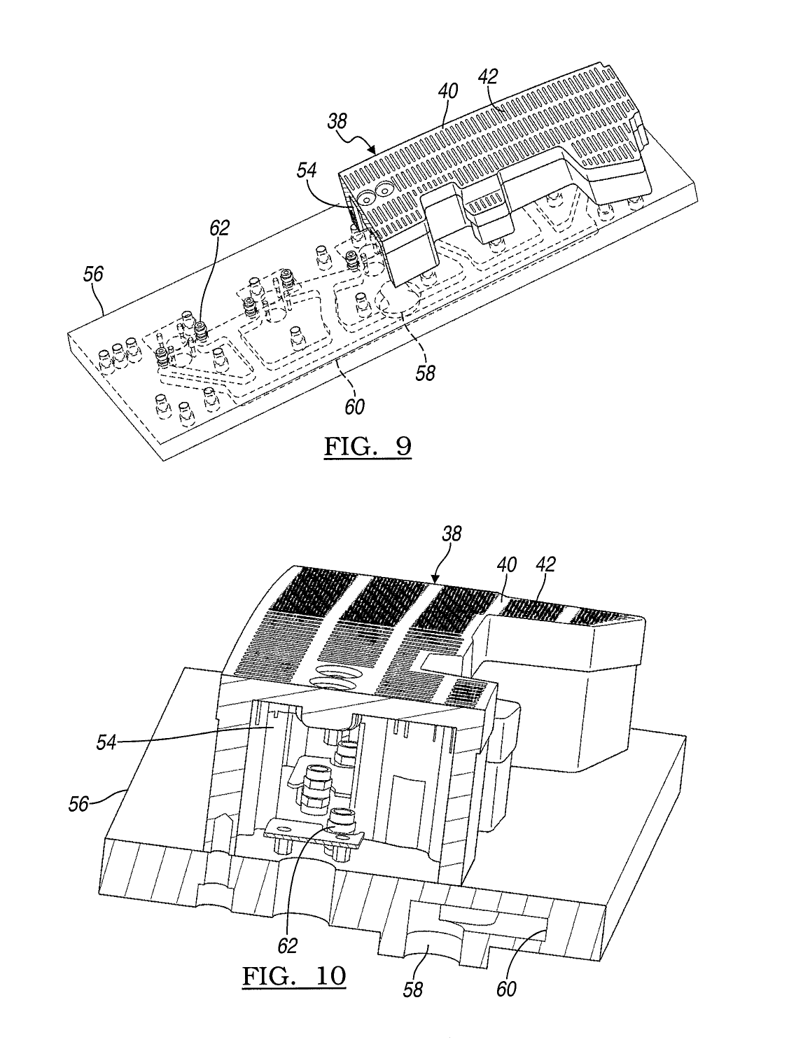

FIGS. 9 and 10 illustrate cross-sections of the mold core portion 38 according to another embodiment. The underside of the body of the mold core portion 38 is open providing a steam chamber 54 collectively with a manifold plate 56. The manifold plate 56 includes a port 58 for receiving steam from a steam generator. The port 58 is coupled to a manifold 60, which distributes the steam to a series of nozzles 62. The nozzles 62 are spaced to evenly distribute the steam within the steam chamber 54, for consequently conveying the steam through the vents 42 through the forming surface 40 to the foam beads.

The mold cavity portion 44 may also employ an integral steam chamber or a steam chamber in cooperation with the manifold plate. Both of these options distribute the steam directly to the forming surface of the beads thereby minimizing an overall volume of steam required and thereby creating energy savings in the generation of steam. Additionally, by minimizing the overall thermal mass of the mold portions 38, 44, less energy is required to heat up the mold portions 38, 44 and cool the mold portions 38, 44. Additionally, due to the efficient heating and cooling of the foam beads and associated tooling, cycle time for manufacturing the molded component is greatly reduced.

Aluminum satisfies the mechanical properties, such as heat transfer and structural integrity, for various molding applications. When aluminum tool applications utilize laminate mold tooling, aluminum brazing of the laminated tool may be performed to bond the layers together. The methodology applied for non-ferrous materials, such as aluminum, can also be applied to ferrous materials, but should consider process and material factors when applied.

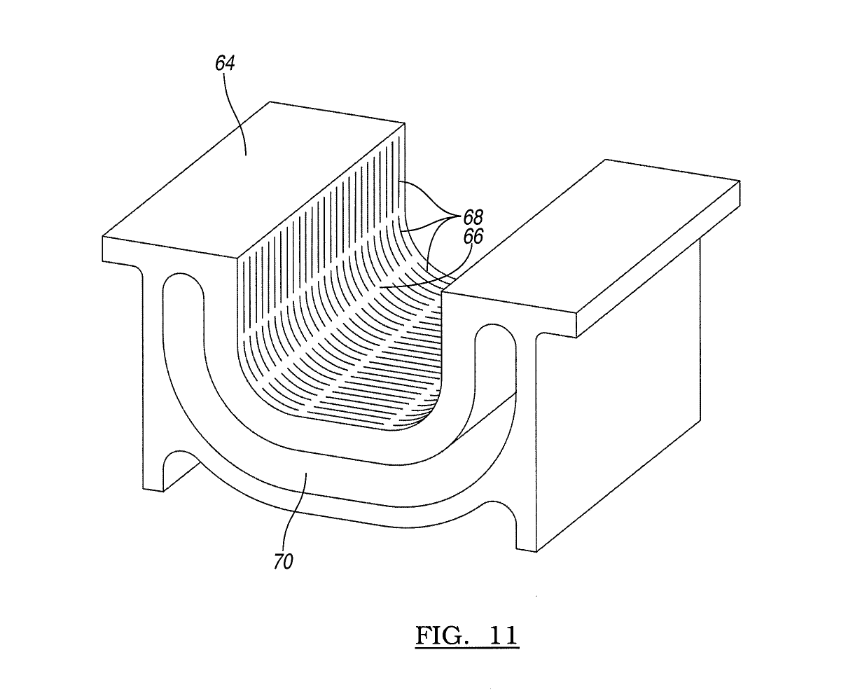

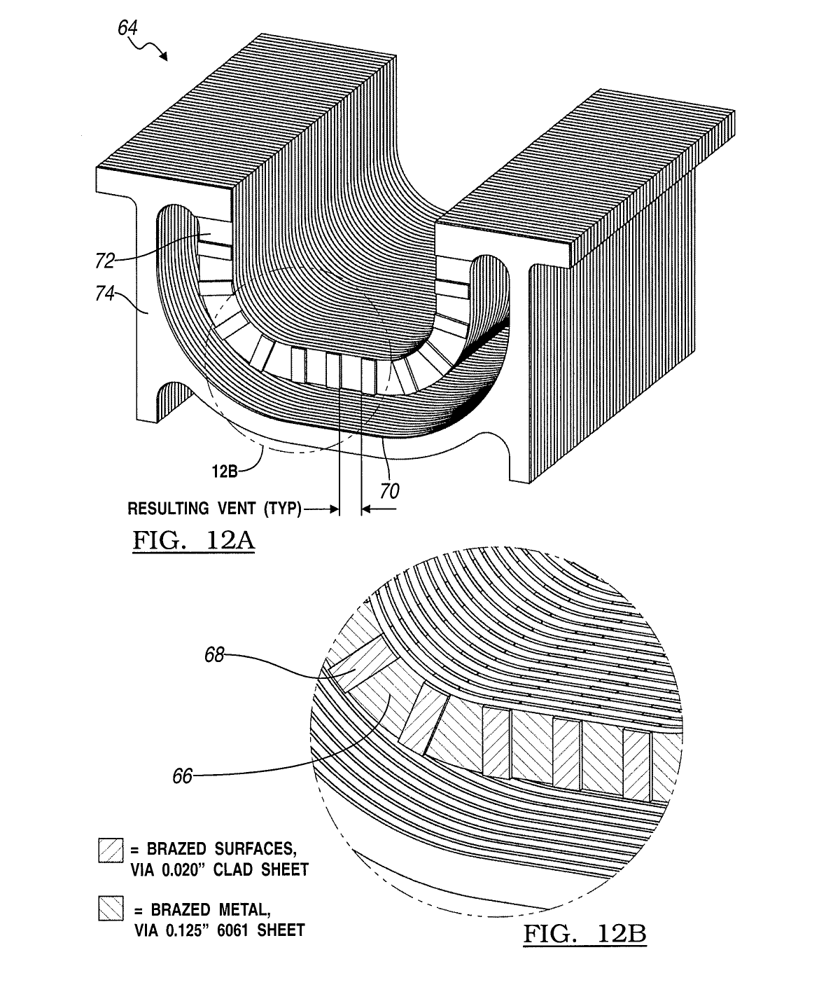

One suitable main base material utilized in the laminated tooling process is 6061-T6 aluminum alloy. The laminate tooling process utilizes an assembly of aluminum blanks that are cut via a laser, a water jet, or the like, to the specified design. FIG. 11 illustrates a finish machined, vented, mold cavity portion 64 that is formed from aluminum plates. The tool includes a forming surface 66 with a series of vents 68 formed through the forming surface, and connected to an internal steam chamber 70. FIG. 12 is a cross section of the mold cavity portion 64 illustrating the cooperation of laminate plates 72, 74 at the brazed surfaces to collectively provide the vents 68.

When the design of the laminate tool 64 is complete, data is generated to build the component 64 from blanks 72, such as 0.125 inch thick blanks of 6061-T6 aluminum. The thickness of the blanks 72 is not limited to 0.125 inch thickness. The blank thickness is driven by the requirements of the design and ability to achieve near net shape of the required geometry when applicable. The thermal mass of the tool design is considered to optimize heating and cooling efficiency of the tool 64 during manufacturing production of an expanded plastic foam product. Therefore, finite element analysis is performed to validate the design and integrity of the tool 64 due the reduction in tool mass. FIG. 13 illustrates a stress distribution model of the tool 64.

During the cutting of the main base metal blanks 72, the number of each blank 72 is identified in the blank 72 to allow the correct order of the blanks 72 during assembly. Braze joint tolerances are often very high, and therefore the base metal in the T6 (hardest) conditioned can be utilized to minimize and prevent any distortion and/or disruption to the surfaces being brazed during the material handling and assembly operations of the laminate tooling process. The assembly of the laminate tooling 64 utilizes a braze layer assembly 74 between each of the main base metal blanks 72. Each braze layer assembly includes a braze alloy material. For the vented tool process, the braze alloy used for brazing 6061-T6 aluminum can be 4047 or 4343 aluminum alloy. The braze alloys can be used in different forms such as foil or clad sheet. The selection of braze alloy material is determined by material flow at liquid state, melting point temperature range, metallurgical compatibility with base alloy, mechanical properties, and commercial availability. The braze foil or clad sheet thickness, may vary based upon the desired resulting vent thickness or gap. Minimizing braze material thickness reduces excess braze material closing off the vents 68 and minimizes resulting braze joint thickness for optimum mechanical properties.

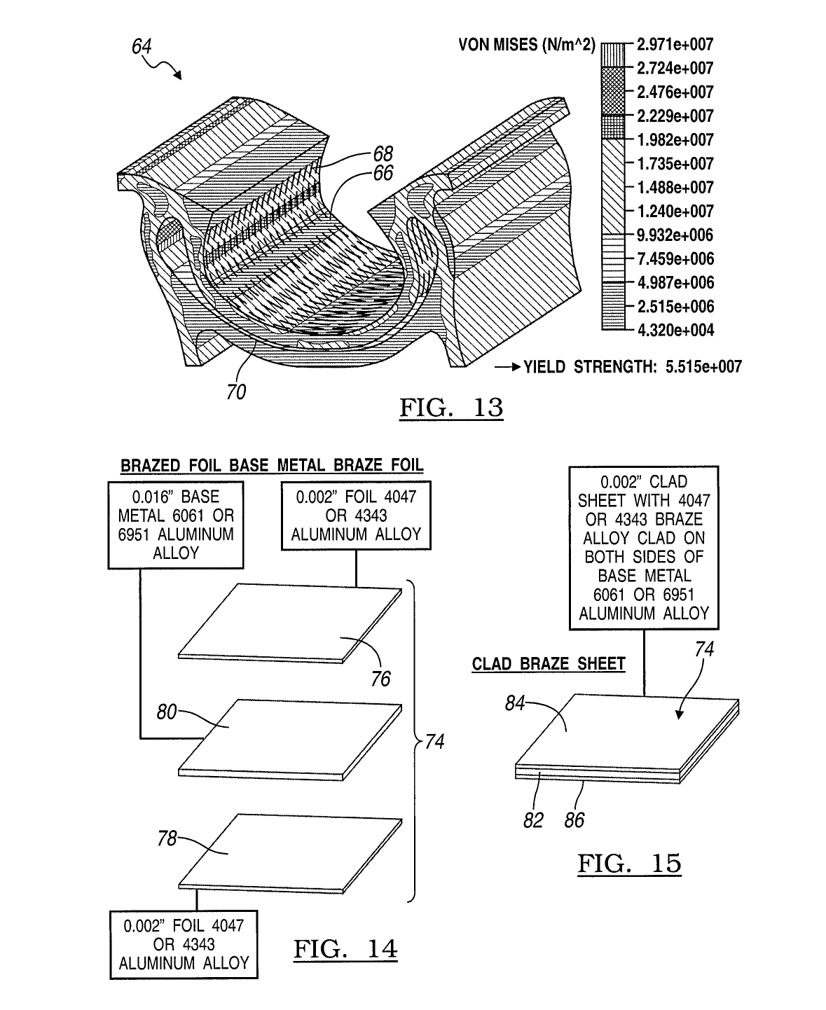

Referring now to FIG. 14, the braze layer assembly 74 includes a pair of braze foil sheets 76, 78 and a base metal intermediate blank 80. The braze foil sheets 76, 78 may each be provided by 4047 of 4343 aluminum alloy. The base metal intermediate blank 80 may be provided by the base metal material, 6061-T6 aluminum. During a brazing process, the braze foil sheets 76, 78 braze a base metal intermediate blank 80 to a pair of adjacent base metal layers 72. The braze layer assembly 74 collectively has a thickness that is less than a base metal layer 72. Additionally, the braze foil sheets 76, 78 each have a thickness less than that of the base metal intermediate blank 80. For example, the braze foil sheets 76, 78 may each have a thickness of 0.002 inches; and the base metal intermediate blank 80 may have a thickness of 0.016 inches. After the brazing process, the braze layer assembly 74 thickness is generally equivalent to the desired vent thickness of approximately 0.018 inches due to a braze material runoff equivalent to approximately 0.002 inches.

FIG. 15 illustrates another embodiment braze layer assembly 74 provided by a core base metal intermediate blank 82 with braze alloy layers 84, 86 clad on both sides of the base metal intermediate blank 82. The thickness of the braze alloy layers 84, 86 on each side of the base metal intermediate blank 82 can each be generally ten percent of the overall thickness of the clad braze layer assembly 74.

The braze layer assembly 74 is cut to the same shape as the outside profile of the base metal cut blank 72. The braze layer assembly 74 also includes the geometry to create the vents 68 in the designed locations. Therefore, the braze layer assembly 74 differs from the base metal cut blank 72 in the areas of the geometry of the vents 68 relative to the overall geometry of the finished tool 64. The design of the vented tool 64 includes excess material to allow for finish machining, and is utilized for providing the braze layer assembly 74 as one piece.

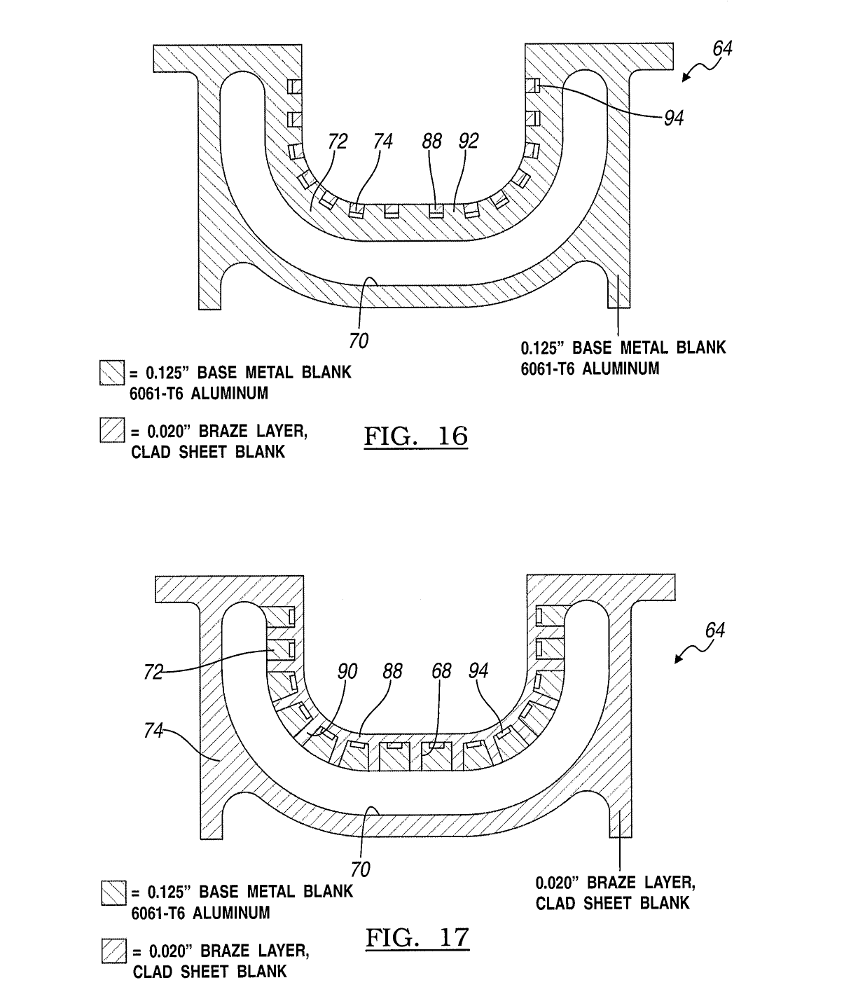

FIG. 16 illustrates one of the base metal blanks 72 stacked in alignment with a braze layer assembly 74. In order to improve the efficiency of the brazing process, all internal features are exposed to the outside surface of the part 64 being brazed. Therefore, any vent 68 that passes from the outside surface to internal contours is open on both ends to prevent an accumulation of excess braze due to the high surface tension of the braze alloy at liquid state. FIG. 17 illustrates an excess material region 88 provided on the braze layer assembly 74. The excess material region 88 interconnects a series of spacers 90 that remain after the vents 68 are removed. The excess material region 88 maintains the alignment of the spacers 90 and consequently the vents 68 for proper alignment in brazing of the tool 64. The excess material region 88 also provides material for machining and relief in design to allow for venting from inside features to outside surfaces. Referring again to FIG. 16, an excess material region 92 is also provided in the base metal blanks 72. The excess material region 92 provides excess material for machining an relief in design. A series of vents 94 are provided in the excess material region 92 to allow for venting of the tool vents 68, which would otherwise be enclosed by the excess material regions 88, 92 of the braze layer assembly 74 and the base metal blank 72 respectively.

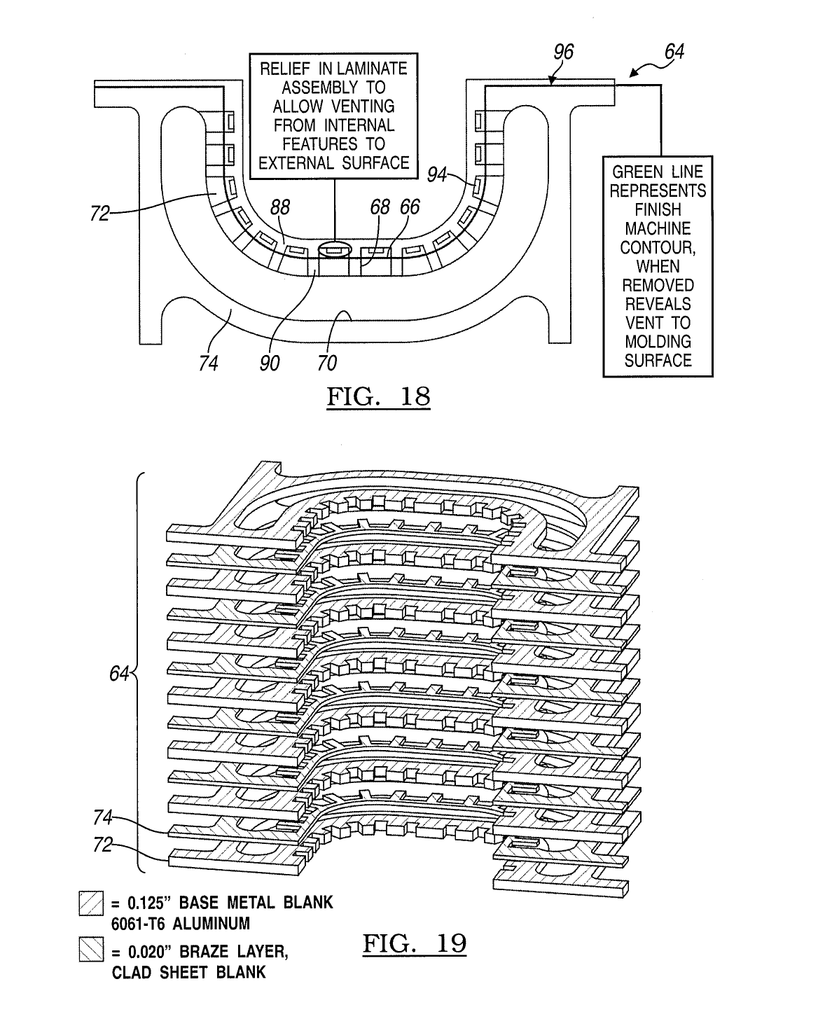

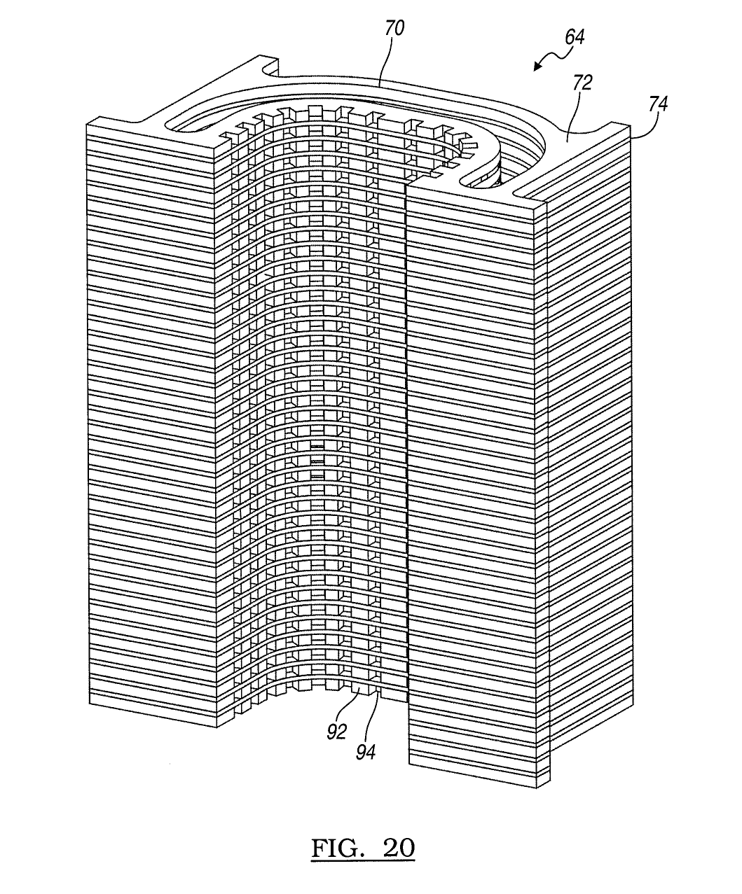

FIG. 18 illustrates the stacked base metal blanks 72 and the braze layer assemblies 74. A final forming surface 96 is illustrated, which will be machined into the tool 64 after the brazing process. The vents 94 in the base metal blanks 72 intersect with the vents 68 of the braze layer assemblies within the excess material regions 88, 92 that are outside the forming surface 96. Thus, the vents 94 in the base metal blanks 72 are removed with the final machining that removes the excess material regions 88, 92. The final machining operation removes the excess material regions 88, 92 thereby exposing the vents 68, which connect the steam chamber 70 with the forming surface 66.

After cutting of the blanks 72 and the braze layer assemblies 74 is complete, the base metal cut blanks 72 and the braze layer assemblies 74 undergo mechanical abrasion of surfaces. This allows for deburring and increases the amount of braze surface area. This operation can be done by dual action sanding of surfaces. For at least one embodiment, the media used for this operation is not any form of an oxide, which could contaminate the brazing surface. Silicon Carbide abrasives are utilized to prevent any introduction of oxides to the surfaces to be brazed.

Upon completion of mechanical abrasion, the base metal blanks 72 and braze layer assemblies 74 are cleaned in an acetone solution, and then dried. The next step is to rack the base metal blanks 72 and braze layer assemblies 74 and submerge these components into a five percent alkali solution, which is at a temperature of 120-140 degrees Fahrenheit for four to six minutes. The alkali solution allows the base metal blanks 72 and braze layer assemblies 74 to be cleaned and removes any contamination. The base metal blanks 72 and the braze layer assemblies 74 are removed from the alkali solution and rinsed with deionized water for neutralization. The base metal blanks 72 and braze layer assemblies 74 are then submerged into a ten to twelve percent acid (hydrofluoric and nitric) solution for four to six minutes. The acid solution provides deoxidation of the material braze surfaces.

Upon removal of the base metal blanks 72 and braze layer assemblies 74 from the acid, the parts 72, 74 are rinsed with deionized water for neutralization and then dried with clean dry air. Suitable drying conditions can be performed in a recirculating air oven at a temperature of 300 degrees Fahrenheit to reduce any moisture. When drying of the base metal blanks 72 and braze layer assemblies 74 is complete, the assembly process of the laminate component 64 is immediately performed. If assembly of the laminate component 64 is not immediately performed the layers 72, 74 can be stored in air tight containers to minimize the exposure to air preventing oxidation of the prepared components.

The laminate component 64 is assembled with the blanks 72 and braze layer assemblies 74 in the horizontal plane as illustrated in FIG. 19. The assembly of the components 72, 74 may be performed in a clean dust free area. Manual handling of the blanks 72 and braze layer assemblies 74 may be performed with rubber gloves to prevent contamination from being introduced on any of the brazing surfaces of the components 72, 74.

Beginning with the first base metal blank 72 placed on a work surface, a braze layer assembly 74 is then placed between each base metal blank 72 as it is stacked up. During the assembly of the laminate component 64, alignment of the base metal blanks 72 and the braze layer assemblies 74 is maintained. There is not a need to puncture the braze layer assemblies 74 for venting, because it has already been cut, via laser, water jet, wire EDM, or other means, to the shape revealing all internal features and vents 68. The overlapping vents 68, 94 minimize excess braze material, prevent trapped air in the assembled component 64 eliminating the chance for braze material blowout during phase change to liquidus state, and allow all internal features to be in equilibrium with the brazing environment/atmosphere. When the assembly of the laminate component 64 is completed the laminate component 64 is ready to be installed onto a brazing fixture and then immediately into the vacuum furnace. FIG. 9 illustrates the assembled tool 64. If the laminate component 64 cannot be immediately placed in the vacuum furnace, the components 72, 74 can be stored in an inert environment container or one which is free of oxygen.

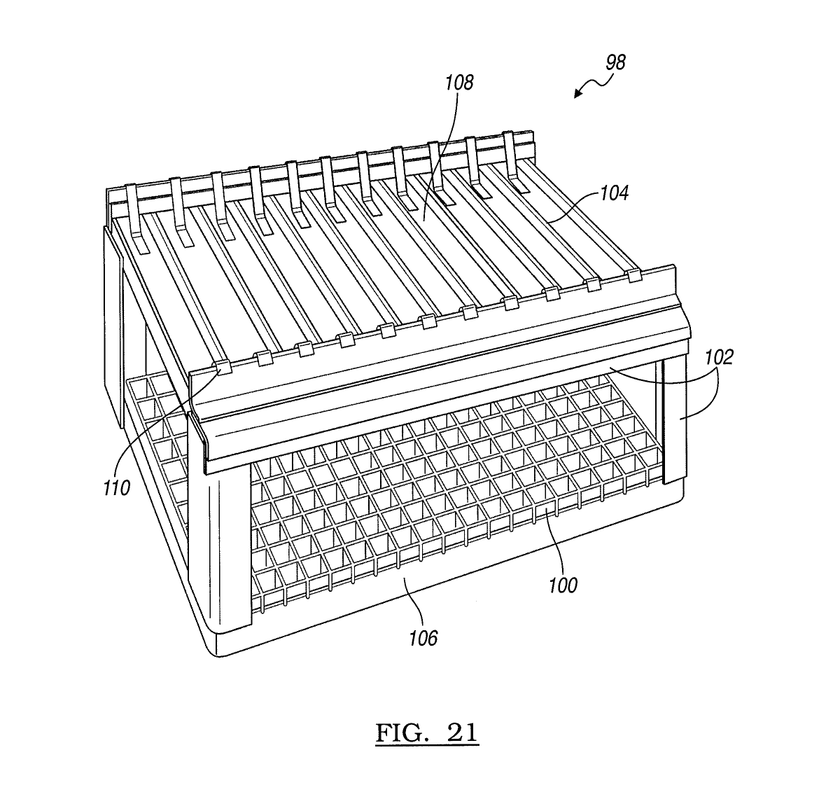

Referring now to FIG. 21, a brazing fixture 98 may be employed for the laminate tooling 64, or component, aluminum brazing process. The brazing fixture 98 is designed and built with materials that have excellent high strength properties and at high temperatures, utilizes a low mass design to prevent a heat sink effect yet providing structural strength, and provides a system to apply distributed forces to the brazed components 64 for compression throughout the braze cycle while maintaining a fixed position of the component 64 on the fixture 98.

The braze fixture 98 is a rack type braze fixture that includes a base 100, a frame 102, and a top 104. The base 100 is manufactured from an austenitic nickel-chromium-based superalloy sheet, such as Inconel® 750X sheet, from Special Metals Corporation in Huntington, W. Va., USA. The sheet is welded yielding a honeycomb construction. The base 100 is then solution heat treated, age hardened, and top and bottom surfaces machined parallel. Gussets 106 are manufactured from 304 stainless steel, and are welded to the bottom of the base 100 creating an X-brace and perimeter frame for additional structural strength. The base 100 is then stress relieved at a temperature below the age hardening temperature of the sheet material, so the required properties of the sheet material are not affected. The top and bottom of the base 100 are then precision ground on top and bottom to provide flat and parallel surfaces.

The frame 102 of the fixture 98 is manufactured from 304 stainless steel sheet that has been formed to create angles and structure for optimal strength. The components of the frame 102 are welded together then stress relieved. The frame 102 is then fastened to the fixture base 100 utilizing high strength stainless steel fasteners. The top 104 of the fixture 98 is manufactured from 304 stainless steel sheet that has been formed into u-shaped channels 108 for structural strength. Tabs 110 are welded on each end of the u-channels 108 to create a hook. The components of the top 104 are stress relieved. Several of the u-channels 108 are used to create the top 104 of fixture 98, and hook on to the frame 102 of the fixture 98 to maintain position.

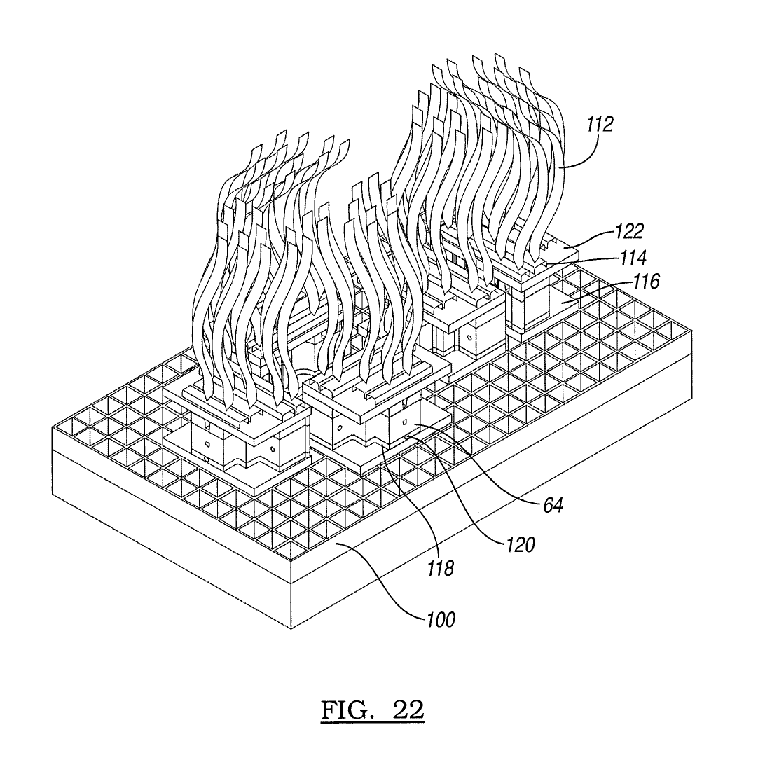

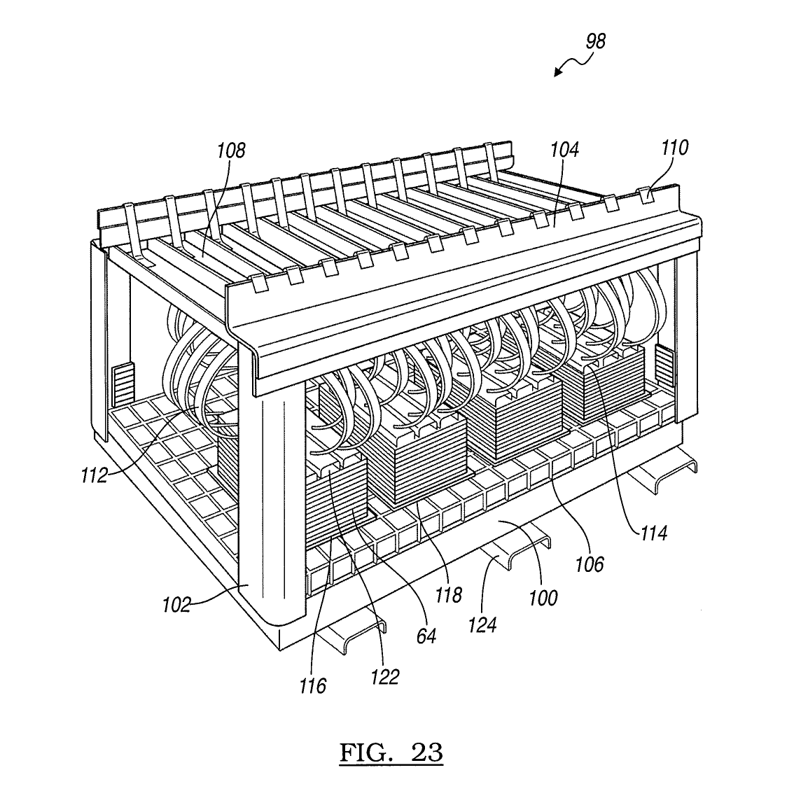

Reduction in mass results in reduction of thermal mass, thereby providing a reduction in cycle time in the vacuum furnace. Referring to FIGS. 22 and 23 additional mass can be reduced by utilizing high temperature alloy springs, such as ribbon springs 112 manufactured from an austenitic nickel-chromium-based superalloy sheet, such as Inconel® 750X sheet. The ribbon springs 112 generate a force to be applied to the laminate component 64. The ribbon springs 112 are manufactured from 0.060 inch thick sheet stock and are formed to a specific shape, then solution heat treated and age hardened to maximize mechanical properties and high temperature strength. The ribbon springs 112 maintain their strength and applied force during brazing because the brazing temperatures for aluminum are well below the heat treatment temperatures that would affect the properties of the material. Although ribbon springs 112 are illustrated and described, various spring types may be employed such as coil springs or the like to design to a fixture size and load rate for a specific brazing application.

The ribbon springs 112 provide a force of approximately thirty-five pounds per square inch of the laminate component 64. In order to prevent the ribbon springs 112 from providing point loads upon the laminate component 64, additional supports are employed to distribute the force uniform over the surface of the laminate component 64. As a result load u-channels 114 manufactured from 304 stainless steel are used, typically 0.7-1.5 inches wide by 0.5 inches tall by desired length. The load u-channels 114 are placed on top of the part 64 with edges facing down. The ribbon springs 112 are placed between the top 104 of the braze fixture 98 and the load u-channels 114 on top of the part 64.

The set-up of the laminate components 64 to be brazed, on the brazing fixture 98 can be optimized for the brazing process. Dependent on the size of laminate component 64, multiple components 64 can be set-up on the fixture 98 for a single furnace run. To determine the layout of multiple components 64, a minimum of 1.5 inches spacing can be maintained between components 64. The following describes a method, for example, for preparing each laminate component 64 for brazing on the braze fixture 98. A rectangular 0.060 inch thick 304 stainless steel sheet base plate 116 is provided 0.25 inch wider than the profile of the component 64 to be brazed. The base plate 116 is placed on the base 100 of the fixture 98 in the determined location. The base plate 116 has been stress relieved, painted with Magnesium Hydroxide, and dried before being used in the set-up. The base plate 116 provides a flat surface for the laminate component 64 and load distribution to the honeycomb base 100.

An aluminum vent/drain plate 118 is installed on top of the base plate 116. The vent/drain plate 118 is the same profile as the laminate component 64, and has passages 120 located in the location of the drain holes in the laminate component 64 and to the outside of the vent plate 118 so the brazing environment/atmosphere is allowed into the internal features of the laminate component 64. The vent/drain plate 118 is painted with Magnesium Hydroxide to prevent brazing of this plate 118 to the laminate component 64. The laminate component 64 is placed on the vent/drain plate 118. Another base plate 122 is then installed on top of the laminate component 64. The base plate 122 in this location, provides a flat surface for load distribution on the laminate component 64 surface.

The load u-channels 114 are placed with the edges on top of the base plate 122 so that the u-channels 114 cover the entire surface of the laminate component 64 and extend just beyond the component 64 in length. A minimum force is determined using a calculation which considers cross sectional surface area and the number of base metal blanks 72 and layers 74 of the laminate component 64. The force allows compression of the blanks 72 and layers 74, maintaining flatness, constraining the location of the laminate component 64 on the fixture, and consistent braze joint thickness. The ribbon springs 112 are installed between the load u-channels 114 and the top of the braze fixture 98. The ribbon springs 112 are compressed to install into the braze fixture 98, and total force is determined by the measurable pre-load of the spring 112 multiplied by the spring rate multiplied by the total number of springs 112 per laminate component 64. This total force is designed to be greater than or equal to the calculated force required during the brazing operation.

Load thermocouples are used during the brazing process that are sheathed in an austenitic nickel-chromium-based superalloy, such as Inconel®, from Special Metals Corporation in Huntington, W. Va., USA. A minimum of two load thermocouples are used and the first is installed in the laminate component 64 closest to center of the fixture 98, and a second in another laminate component 64 on a peripheral region of the fixture 98. Although the brazing process occurs in high vacuum levels, the possibility of oxide is still present due to oxides or oxygen bearing medium that may be existing within the base metal and peripheral materials. To further prevent oxidation of the aluminum laminate component 64, high purity Magnesium turnings are placed on top of the braze fixture 98. During the brazing cycle the Magnesium vaporizes in the brazing environment then allowing reaction with any oxygen that may be present and prevent/reduce oxidation of the aluminum. The required mass of Magnesium turnings is dependent on the braze furnace volume and duration of the brazing cycle.

Once all the laminate components 64 are installed on the braze fixture 98 as discussed, the loaded braze fixture 98 can be installed on a furnace load cart. When loading the braze fixture 98 on the furnace load cart, the braze fixture 98 can be installed on a plurality of support cross bars 124. A small amount of Magnesium turnings is also placed into each of the support cross bars 124. The loaded braze fixture 98 is subsequently installed in the vacuum furnace.

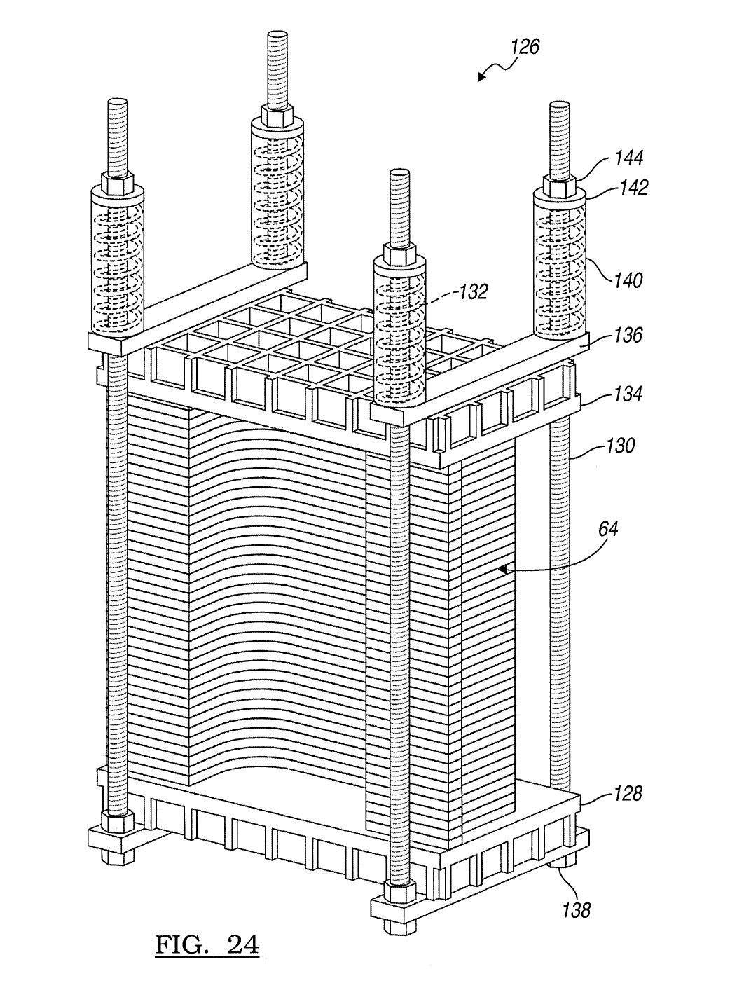

Of course, various brazing fixture variations may be employed under the spirit and scope of the invention. The varying geometries of tools may result in various configurations of the braze fixture. Referring now to FIG. 24, a braze fixture 126 is illustrated for fixturing the laminate tool 64. The braze fixture 126 includes a lower platen 128, tie rods 130, spring assemblies 132, and an upper platen 134. The braze fixture 123 may be utilized for taller laminate assemblies 64, which may exceed the rack fixture 98 limitations of the prior embodiment.

The lower platen 128 and the upper platen 134 are constructed of 304 stainless steel, and are designed so they have minimal mass and maintain structural strength. Holes can be drilled in the platens 128, 134 to reduce mass and to also provide vent holes for the laminate component 64 when placed on the lower platen 128. The vent holes in the lower platen 128 are located between the support structures of the lower platen 128. The lower and upper platens 128, 134 have cross bars 136, also made of 304 stainless steel, welded to the platens 128, 134 which provide a fastener configuration for the tie rods 130 and the spring assemblies 132 to fasten the fixture 126 together and apply a compressive force to the laminate component 64. The platens 128, 134 after weld assembly, are stress relieved, machined and ground flat, and furnace degassed prior to utilization during brazing. The threaded rods 130 and associated fasteners 138 are made from 304 stainless steel are fastened to the lower platen 128 about the perimeter of the laminate tool 64 and extend above the height of the laminate tool 64. The upper platen 134 is placed upon the laminate tool 64 in sliding engagement with the threaded rods 130. The coil springs 132 are each formed from a high temperature alloy such as Inconel® 750X. The coil springs 132 can be engineered for a specific size and load rate. The coil springs 132 are each placed about one of the threaded rods 130 in engagement with the upper platen 134.

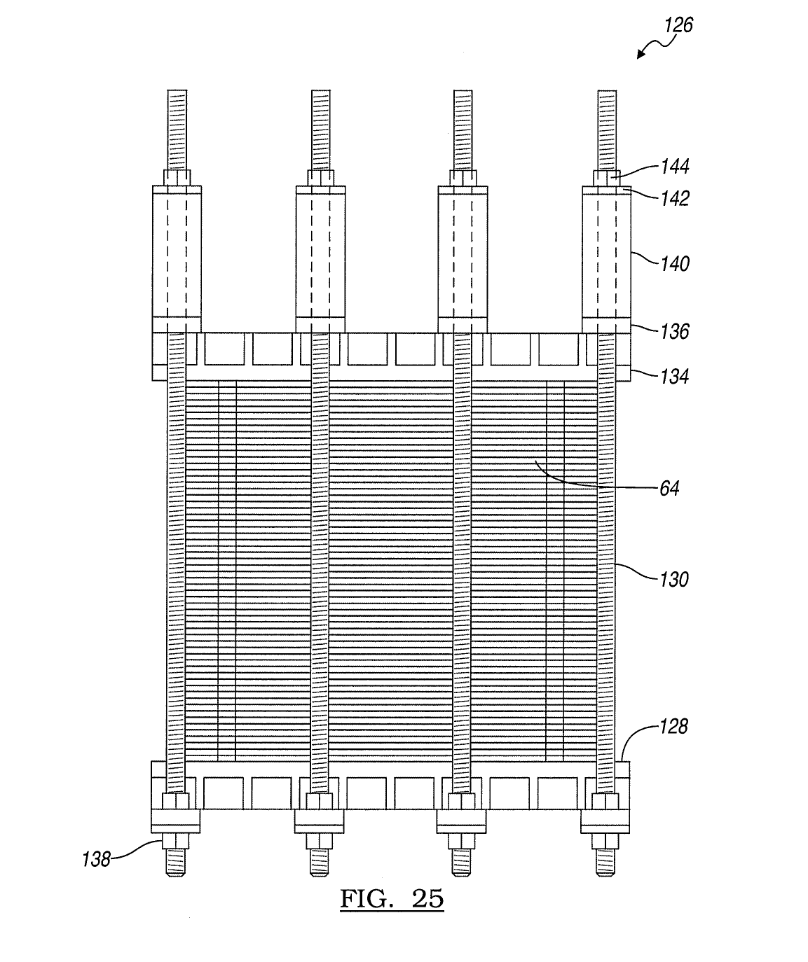

A 304 stainless steel tube 140 is placed about each coil spring 132. The length of each preload tube 140 is determined by desired force to be applied by each spring 132. The preload length calculation is: the preload tube 140 length is equal to the overall spring 132 length minus desired load per spring 132 load rate. Note, all components may be cleaned and furnace degassed prior to utilizing them in a braze process. FIG. 25 illustrates another embodiment that utilizes additional cross bars 136, threaded rods 130 and coil springs 132 to obtain a desired force upon the laminate tool 64.

The set-up of the laminate components 64 to be brazed, on the brazing fixture 126 can be optimized for the brazing process. Dependent on the size of laminate component 64, multiple components 64 can be set-up on the fixture 126 for a single furnace run. To determine the layout of multiple components 64, a minimum of 1.5 inches spacing can be maintained between components 64. The following describes a method, for example, for preparing each laminate component 64 for brazing on the braze fixture 126. The lower platen 128 is placed on a work surface. The lower platen 128 has been stress relieved, painted with Magnesium Hydroxide, and dried before being used in the set-up. The tie rods 130 are installed and fastened to lower platen 128. The length of the tie rods 130 may be determined by maximum work envelope in the applicable vacuum furnace performing the brazing. The tie rods 130 have been stress relieved, painted with Magnesium Hydroxide, and dried before being used in the set-up.

A vent plate may be installed on top of the lower platen 128 to allow alignment of the vent holes in the lower platen 128 to vent holes of internal features of the laminate tool 64. In some applications, the vent plate may not be required because vent holes in the lower platen 128 may align with the laminate tool vent holes. The vent plate can be manufactured from aluminum and is painted with Magnesium Hydroxide, and dried before being used in the set-up. The assembled laminate tool 64 is placed onto the lower platen 128 and centered. Once the laminate tool 64 is installed on lower platen 128, straightness and squareness of the laminate tool 64 is verified. An upper vent plate may be installed on top of the laminate tool 64 to allow alignment of the vent holes of the laminate tool 64 with the upper platen 134 vent holes. In some applications, the vent plate may not be required because vent holes in the upper platen 134 may align with the laminate tool 64 vent holes.

The upper platen 134 is installed on top of the laminate tool 64, passing the tie rods 130 through the upper platen 134. The upper platen 134 has been stress relieved, painted with Magnesium Hydroxide, and dried before being used in the set-up. The coil springs 132 are installed on each of the tie rods 130. The stainless steel preload tubes 140 are installed around the springs 132. Flat washers 142 are installed on the springs 132; and nuts 144 are installed on each tie rod 130 engaging the flat washers 142. The nuts 144 are then alternately tightened evenly until the springs 132 are compressed and until the washers 142 engage the preload tubes 140. Magnesium turnings are placed on the lower platen 128 around the laminate tool 64, and on top of the upper platen 134. The braze fixture assembly 126 with the laminate tool 64 is then installed into the furnace.

The vacuum furnace used for the aluminum brazing process of the laminate tooling 64, or component, may be designed specifically for aluminum brazing. Typically, aluminum brazing vacuum furnaces possess the following functionality: a nickel chrome based hot zone which can endure the thermal stress of backfilling and opening at brazing temperatures at approximately 1100 degrees Fahrenheit; a recirculation cooling system for the chamber to allow and maintain an elevated temperature of approximately 140 degrees Fahrenheit; an oversized vacuum system achieving 10⁻⁴ to 10⁻⁵ torr; high tolerance temperature control of plus or minus five degrees Fahrenheit through a 1000 to 1200 degrees Fahrenheit range; while satisfying AMS 2750 standard.

Prior to performing the aluminum brazing process in the vacuum furnace, a vacuum furnace pre-heat cycle is performed heating the chamber to 1000 degrees Fahrenheit at a pressure less than 10⁻⁴ torr. The furnace chamber water temperature may be increased between 100 and 130 degrees Fahrenheit so that relative humidity is decreased to reduce or prevent moisture in the furnace. The furnace chamber water temperature can be increased during the furnace pre-heat cycle.

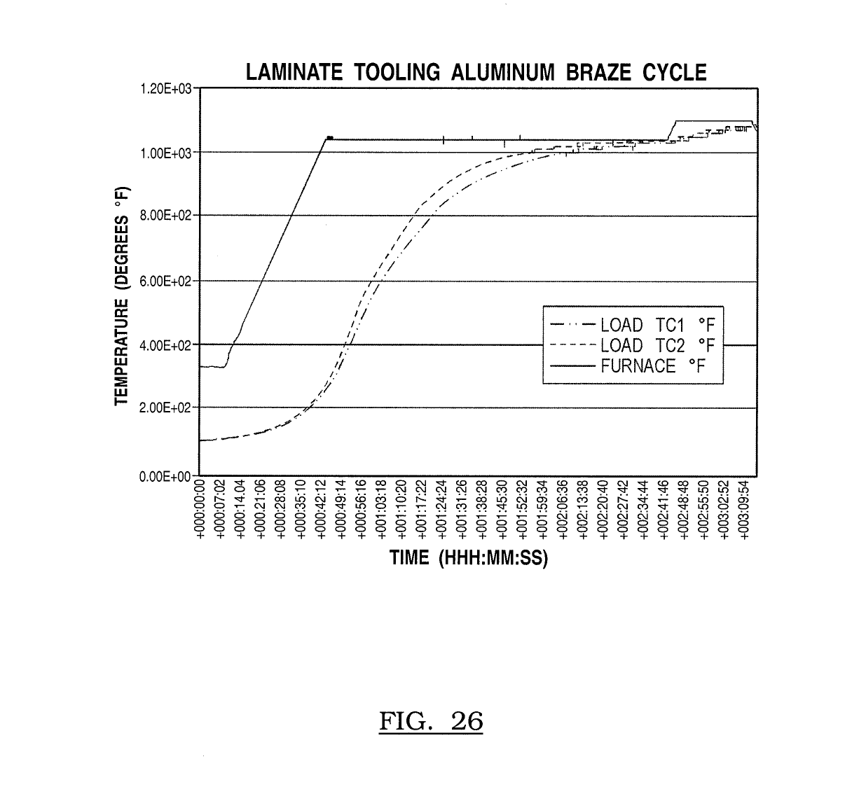

With the furnace pre-heat cycle complete and the braze fixture set-up complete, the aluminum braze cycle, is initiated as illustrated in FIG. 26 with the temperatures of the furnace, and the load thermocouples TC1, TC2 graphed versus time. The vacuum furnace chamber is backfilled with nitrogen. Then, the furnace door is opened and the braze fixture 126 is loaded in the furnace. The furnace door is closed, and the furnace chamber is pumped down to 100 μm. Then the chamber is backfilled with nitrogen to a ten inch vacuum, which is repeated three times. Next the chamber is pumped down to less than 10⁻⁴ torr. Subsequently the furnace temperature is ramped to 300 degrees Fahrenheit and maintained for one minute. The furnace temperature is then ramped to 1040 degrees Fahrenheit plus or minus five degrees Fahrenheit at a rate of twenty degrees Fahrenheit per minute. This temperature is maintained until the load thermocouples reach 1040 degrees Fahrenheit plus or minus five degrees Fahrenheit. The furnace temperature is then ramped to 1100 degrees Fahrenheit at a rate of twenty degrees Fahrenheit per minute until the load thermocouples reaches 1080 degrees Fahrenheit plus or minus five degrees Fahrenheit. The heat is disabled and the chamber is backfilled with nitrogen until the furnace door is opened. The load thermocouples are removed and the braze fixture 126 is removed from the furnace. The furnace door is closed, and the brazed laminate components 64 are air cooled in the braze fixture 126 under load until the component temperature is less than 500 degrees Fahrenheit. While cooling to room temperature, when the laminate parts 64 reaches 985 degrees Fahrenheit, the heat can be turned off for cooling at maximum rate to room temperature. The 1100 degrees Fahrenheit furnace braze temperature and the load thermocouple temperature of 1085 degrees Fahrenheit may vary due to different braze alloys being used. For example, 4343 aluminum has a higher liquidus temperature than 4047 aluminum so an increase in these temperatures may be utilized. The braze fixture is disassembled and the brazed laminate components 48 are removed.

Additional heat treatment of the brazed laminate components 64 may be employed, depending on the final material specifications. Solution heat treatment of the 6061 laminate components 64 may be utilized, and a standard water quench process can be used to achieve the T4 condition of the 6061 aluminum. The 6061 laminate components 64 may then be age hardened to a T6 condition.

Methods to create vents, passages, orifices of different sizes, from internal volumes to forming surfaces, within tool via braze layer, can be provided by either by a braze clad sheet or braze foil and base metal blanks.

A method of creating a pressure vessel within a tool to allow distribution and delivery of a gas, liquid, and/or solid from a supply source to the created vents, passages, orifices is provided.

Optimization of laminate component heating and cooling efficiency by vents, passages, orifices, and undulations to induce turbulent fluid flow, and reduction in thermal mass results in reduced energy storage, while considering material physical properties for the defined application.

Management, and/or minimization of braze alloy flow during brazing process can be provided via design of internal passages and geometry, venting of passages, reduction of thermal mass, and utilization of vent plates.

Aluminum braze fixtures with low thermal mass minimize/prevent heat sink affect with brazed components, maintain high temperature strength to ensure flatness of parts and uniform distribution of forces, resulting in uniform braze joint thickness and mechanical and thermal properties.

The utilization of mechanical and chemical cleaning process to clean and deoxidize base metal and braze layer optimizes brazability of required surfaces.

The utilization of Magnesium turnings prevents oxide formation on brazed surfaces during the vacuum furnace brazing cycle.

The aluminum brazed laminate component provides mechanical properties near or equivalent to that of the base metal.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed is:

1. A method for forming a tool for forming an article comprising:
providing a series of laminate layers to collectively form a tool body;
forming a first plurality of the laminate layers with a forming surface for forming an article in a forming operation;
forming a second plurality of the laminate layers with a forming surface for forming an article in a forming operation collectively with the forming surface of the first plurality of the laminate layers;
forming a chamber through the first and second pluralities of laminate layers offset from the forming surface;
forming a vent in each of the second plurality of laminate layers intersecting the forming surface and the chamber;
stacking the series of laminate layers such that each of the first plurality of the laminate layers is alternating with the second plurality of the laminate layers; and
heating the stacked series of laminate layers to a temperature wherein the layers braze together.
